(19) United States
(12) Patent Application Publication
(10) Pub. No.: US 2007/0178298 A1
(43) Pub. Date: Aug. 2, 2007

(54) Curable liquid composition, cured film, and antistatic laminate

(75) Inventors: Yasunobu Suzuki, Tokyo (JP); Ryousuke Iinuma, Tokyo (JP); Noriyasu Shinohara, Tokyo (JP); Zen Komiya, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: DSM IP ASSETS B.V., TE HEERLEN (NL); JSR CORPORATION, TOKYO (JP); JAPAN FINE COATINGS CO., LTD, IBARAKI (JP)

(21) Appl. No.: 10/593,490

(22) PCT Filed: Mar. 25, 2005
(86) PCT No.: PCT/NL05/00228

§ 371 Date: Jan. 11, 2007

(30) Foreign Application Priority Data
Mar. 25, 2004 (JP) 2004/089375

(51) Int. Cl. B32B 27/40; B32B 27/20; B32B 5/16; B32B 27/00

(52) U.S. Cl. 428/323; 428/423.1

(57) ABSTRACT

To provide a curable composition having excellent applicability and capable of forming a coat (film) having high hardness and high refractive index and excelling in scratch resistance and adhesion to a substrate and a low-refractive-index layer on the surface of various types of substrates, a cured product of the curable composition, and a laminate having a low reflectance and excelling in antistatic property. A curate e composition comprising particles (A) prepared by bonding oxide particles of at least one element selected from the group consisting of silicon, aluminum, zirconium, titanium, zinc, germanium, indium, tin, antimony, and cerium with an organic compound having a polymerizable unsaturated group, a compound (B) having a urethane bond and two or more polymerizable unsaturated groups in the molecule, and a photoinitiator (C).

### FIELD OF THE INVENTION

The present invention relates to a curable composition, a cured product of the curable composition, and a laminate. More particularly, the present invention relates to a curable composition having excellent applicability and adhesion to various types of substrates such as plastics (polycarbonate, polymethylmethacrylate, polystyrene, polyester, polyolefin, epoxy resin, melamine resin, triacetyl cellulose resin, ABS resin, AS resin, norbornene resin, etc.), metals, wood, paper, glass, and slates and capable of forming a coat (film) having high hardness, high refractive index, excellent scratch resistance, and good adhesion to a substrate and a low-refractive-index layer on the surface of the substrate; to a cured product of the curable composition; and to a laminate having a low reflectance and excelling in antistatic properties.

### PRIOR ART

In recent years, as a protective coating material for preventing scratches or stains on the surface of various types of substrates, an adhesive and a sealing material for various types of substrates, and a binder for printing ink, a curable composition having excellent applicability and capable of forming a cured film excelling in hardness, scratch resistance, abrasion resistance, low curling properties, adhesion, transparency, chemical resistance, antistatic properties, and appearance on the surface of various types of substrates has been demanded.

In the application of an antireflection film for film-type liquid crystal elements, touch panels, or plastic optical parts, a curable composition capable of forming a cured film having a high refractive index has been demanded.

Various types of compositions have been proposed to satisfy such demands. However, a curable composition having excellent applicability and capable of producing a cured film having high hardness and high refractive index, excelling in scratch resistance and adhesion to a substrate and a low-refractive-index layer used in a later-described laminate, and having a low reflectance and excellent antistatic properties when used in a laminate in which a low-refractive-index film is applied and laminated on the cured film has not yet been developed.

For example, Patent Document 1 discloses a conductive coating agent comprising ultrafine powder of a conductive filler and a UV-curable resin as a binder. This coating agent can form a cured coating without heating and can easily form a conductive cured coating on a transparent substrate which does not exhibit heat resistance. The specification describes that the conductive filler is preferably antimony-doped titanium oxide for ensuring dispersibility and low haze. The specification also describes that an acrylic resin, urethane resin, or silicone resin is used as the UV curable resin. However, the specification does not suggest that a urethane resin is preferably used for improving adhesion to a substrate. In addition, the conductive coating agent described in Patent Document 1 does not contain a solvent.

Patent Document 2 discloses a photosensitive resin composition for a hard coat agent comprising (A) a (meth)acrylate mixture, (B) a photoinitiator, (C) a urethane oligomer containing an ethylenically unsaturated group, (D) colloidal silica sol, and (E) a diluent and a hard coat film of the composition. The specification describes that the resulting film exhibits excellent pencil hardness, curling properties, and adhesion to a substrate. However, the inorganic particles used in the Examples (the above component (D)) are only silica particles. The surface of the silica particles is not modified. The film does not have conductivity because silica particles are used.

Patent Document 1

Japanese Patent Application Laid-open No. 7-196956, claims 1, 4, and 5, Paragraph [0022], Table 1

Patent Document 2

Japanese Patent Application Laid-open No. 2002-235018, Claims, Paragraph [0037]

### PROBLEMS TO BE SOLVED BY THE INVENTION

The present invention has been achieved in view of the above problems. An object of the present invention is to provide a curable composition having excellent applicability and capable of forming a coat (film) having high hardness and high refractive index and excelling in scratch resistance and adhesion to a substrate and a low-refractive-index layer on the surface of various types of substrates, a cured product of the curable composition, and a laminate having a low reflectance and excelling in antistatic properties.

### MEANS FOR SOLVING THE PROBLEMS

As a result of extensive studies to achieve the above object, the present inventors have found that a cured film excelling in adhesion to a substrate (lower layer) and an upper layer can be obtained by using a curable resin composition comprising a compound having a urethane bond and two or more polymerizable unsaturated groups in the molecule. This finding has led to the completion of the present invention.

The present invention can provide the following curable composition, cured product of the curable composition, and laminate.
[1] A curable composition comprising:
(A) particles prepared by bonding oxide particles of at least one element selected from the group consisting of silicon, aluminum, zirconium, titanium, zinc, germanium, indium, tin, antimony, and cerium with an organic compound having a polymerizable unsaturated group (hereinafter referred to as “component (A)”),
(B) a compound having a urethane bond and two or more polymerizable unsaturated groups in the molecule (hereinafter referred to as “component (B)”), and
(C) a photoinitiator.
[2] The curable composition described in [1] above, further comprising (D) a compound having two or more polymerizable unsaturated groups in the molecule other than the component (B).
[3] The curable composition described in [1] or [2] above, wherein the organic compound having a polymerizable unsaturated group in the component (A) further comprises a group shown by the following formula (1).
   —U—C(═V)—NH— (1)
wherein U represents NH, O (oxygen atom), or S (sulfur atom), and V represents O or S.
[4] A cured product obtained by curing the curable composition described in any one of [1] to [3] above.
[5] A laminate comprising a cured film of the cured product described in [4] above.

### EFFECT OF THE INVENTION

The present invention can provide a curable composition having excellent applicability and capable of forming a coat (film) having high hardness and high refractive index and excelling in antistatic properties and adhesion to a substrate, a low-refractive-index layer, a hard coat layer, and the like on the surface of various types of substrates, a cured product of the curable composition, and a laminate having a low reflectance and excelling in antistatic properties.

### BEST MODE FOR CARRYING OUT THE INVENTION

The curable composition, the cured product of the curable composition, and the laminate of the present invention are described below in detail.

I. Curable Composition

The curable resin composition according to the present invention comprises (A) particles prepared by bonding of oxide particles of at least one element selected from the group consisting of silicon, aluminum, zirconium, titanium, zinc, germanium, indium, tin, antimony, and cerium and an organic compound which comprises a polymerizable unsaturated group (hereinafter may be called “reactive particles (A)” or “component (A)”), (B) a compound having a urethane bond and two or more polymerizable unsaturated groups in the molecule (hereinafter may be called “compound (B)” or “component (B)”), and (C) a photoinitiator (hereinafter may be called “photoinitiator (C)” or “component (C)”).

Each component of the curable composition of the present invention is described below in detail.

1. Reactive Particles (A)

The reactive particles (A) used in the present invention are obtained by bonding the oxide particles (hereinafter referred to from time to time as “oxide particles (Aa)”) of at least one element selected from the group consisting of silicon, aluminum, zirconium, titanium, zinc, germanium, indium, tin, antimony, and cerium with the organic compound (hereinafter referred to from time to time as “organic compound (Ab)”) having a polymerizable unsaturated group (preferably, a specific organic compound having the group shown by the above formula (1)).

(1) Oxide Particles (Aa)

The oxide particles (Aa) used in the present invention are oxide particles of at least one element selected from the group consisting of silicon, aluminum, zirconium, titanium, zinc, germanium, indium, tin, antimony, and cerium from the viewpoint of colorlessness of a cured film of the resulting curable composition.

As examples of the oxide particles (Aa), particles of silica, alumina, zirconia, titanium oxide, zinc oxide, germanium oxide, indium oxide, tin oxide, tin-doped indium oxide (ITO), antimony oxide, cerium oxide, and the like can be given. Of these, particles of silica, alumina, zirconia, and antimony oxide are preferable from the viewpoint of an increase in hardness. These particles may be used either individually or in combination of two or more. The oxide particles (Aa) are preferably either powder or solvent dispersion sol. If the oxide particles are solvent dispersion sol, the dispersion medium is preferably an organic solvent from the viewpoint of miscibility and dispersibility with other components. As examples of organic solvents, alcohols such as methanol, ethanol, isopropanol, butanol, and octanol; ketones such as acetone, methyl ethyl ketone, methyl isobutyl ketone, and cyclohexanone; esters such as ethyl acetate, butyl acetate, ethyl lactate, γ-butyrolactone, propylene glycol monomethyl ether acetate, and propylene glycol monoethyl ether acetate; ethers such as ethylene glycol monomethyl ether and diethylene glycol monobutyl ether; aromatic hydrocarbons such as benzene, toluene, and xylene; amides such as dimethylformamide, dimethylacetamide, and N-methylpyrrolidone; and the like can be given. Of these, methanol, isopropanol, butanol, methyl ethyl ketone, methyl isobutyl ketone, ethyl acetate, butyl acetate, toluene, and xylene are preferable.

The number average particle diameter of the oxide particles (Aa) is preferably from 0.001 to 2 μm, still more preferably from 0.001 to 0.2 μm, and particularly preferably from 0.001 to 0.1 μm. If the number average particle diameter exceeds 2 μm, transparency of the resulting cured product may decrease or surface conditions of the resulting film may be impaired. Various types of surfactants and amines may be added in order to improve dispersibility of the particles.

The number average particle diameter of oxide particles (Aa) can be determined using a dynamic light scattering particle size distribution analyzer manufactured by Horiba, Ltd., for example.

Among silicon oxide particles (silica particles, for example), given as examples of commercially available products of colloidal silica are Methanol Silica Sol, IPA-ST, MEK-ST, NBA-ST, XBA-ST, DMAC-ST, ST-UP, ST-OUP, ST-20, ST-40, ST-C, ST-N, ST-O, ST-50, ST-OL (manufactured by Nissan Chemical Industries, Ltd.), and the like. As powdery silica, products available under the trade names AEROSIL 130, AEROSIL 300, AEROSIL 380, AEROSIL TT600, and AEROSIL OX50 manufactured by Japan Aerosil Co., Ltd., Sildex H31, H32, H51, H52, H121, H122 manufactured by Asahi Glass Co., Ltd., E220A, E220 manufactured by Nippon Silica Industrial Co., Ltd., SYLYSIA470 manufactured by Fuji Silycia Chemical Co., and SG Flake manufactured by Nippon Sheet Glass Co., Ltd., and the like can be given.

Given as commercially available products of aqueous dispersion products of alumina are Alumina Sol-100, -200, -520 (trade names, manufactured by Nissan Chemical Industries, Ltd.); as an isopropanol dispersion of alumina, AS-150I (trade name, manufactured by Sumitomo Osaka Cement Co., Ltd.); as a toluene dispersion of alumina, AS-150T (trade name, manufactured by Sumitomo Osaka Cement Co., Ltd.); as a toluene dispersion of zirconia, HXU-110JC (trade name, manufactured by Sumitomo Osaka Cement Co., Ltd.); as an aqueous dispersion product of zinc antimonate powder, Selnax (trade name, manufactured by Nissan Chemical Industries, Ltd.); as powders and solvent dispersion products of alumina, titanium oxide, tin oxide, indium oxide, zinc oxide, etc., Nanotch, (trade name, manufactured by CI Chemical Co., Ltd.); as an aqueous dispersion sol of antimony dope-tin oxide, SN-100D (trade name, manufactured by Ishihara Sangyo Kaisha, Ltd.); as an ITO powder, a product manufactured by Mitsubishi Material Co., Ltd.; and as an aqueous dispersion of cerium oxide, Needral (trade name, manufactured by Taki Chemical Co., Ltd.).

The shape of the oxide particles (Aa) may be globular, hollow, porous, rod-like, plate-like, fibrous, or amorphous. The oxide particles (Aa) are preferably globular. The specific surface area of the oxide particles (Aa) (determined by a BET method using nitrogen) is preferably from 10 to 1000 m²/g, and still more preferably from 100 to 500 m²/g. The oxide particles (Aa) may be used either in the form of dry powder or dispersion in water or an organic solvent. For example, a dispersion liquid of fine oxide particles known in the art may be used as a solvent dispersion sol of the above oxides. In particular, use of solvent dispersion sol of oxide is preferable in applications in which high transparency of the cured product is necessary.

(2) Organic Compound (Ab)

The organic compound (Ab) used in the present invention is a compound having a polymerizable unsaturated group in the molecule. The organic compound (Ab) is preferably a specific organic compound having the group [—U—C(═V)—NH—] shown by the above formula (1). The organic compound (Ab) preferably has a group [—O—C(═O)—NH—] and at least one of the groups [—O—C(═S)—NH—] and [—S—C(═O)—NH—]. The organic compound (Ab) is preferably either a compound having a silanol group in the molecule or a compound which forms a silanol group by hydrolysis.

(i) Polymerizable Unsaturated Group

There are no specific limitations to the polymerizable unsaturated group included in the organic compound (Ab). An acryloyl group, methacryloyl group, vinyl group, propenyl group, butadienyl group, styryl group, ethynyl group, cinnamoyl group, maleate group, and acrylamide group can be given as suitable examples.

The polymerizable unsaturated group is a structural unit which undergoes addition polymerization by active radical species.

(ii) The Group Shown by Above Formula (1)

The group [—U—C(═V)—NH—] shown by the formula (1) included in the specific organic compound is [—O—C(═O)—NH—], [—O—C(═S)—NH—], [—S—C(═O)—NH—], [—NH—C(═O)—NH—], [—NH—C(═S)—NH—], or [—S—C(═S)—NH—]. These groups may be used either individually or in combination of two or more. Use of the group [—O—C(═O)—NH—] and at least one of the groups [—O—C(═S)—NH—] and [—S—C(═O)—NH—] in combination is preferable from the viewpoint of thermal stability.

The group [—U—C(═V)—NH—] shown by the formula (1) is considered to cause a moderate cohesive force to occur between the molecules due to hydrogen bonds, and provide the resulting cured product with excellent mechanical strength, adhesion to a substrate, heat resistance, and the like.

(iii) Silanol Group or a Group which Forms a Silanol Group by Hydrolysis

The organic compound (Ab) is preferably either a compound having a silanol group in the molecule (hereinafter may be called “silanol group-containing compound”) or a compound which forms a silanol group by hydrolysis (hereinafter may be called “silanol group-forming compound”). As the silanol group-forming compound, a compound in which an alkoxy group, aryloxy group, acetoxy group, amino group, halogen atom, or the like is bonded to a silicon atom can be given. Of these, a compound in which an alkoxy group or an aryloxy group is bonded to a silicon atom, specifically, a compound containing an alkoxysilyl group or a compound containing an aryloxysilyl group is preferable.

The silanol group or the silanol group-forming site of the silanol group-forming compound is a structural unit which is bonded to the oxide particles (Aa) by condensation or condensation occurring after hydrolysis.

(iv) Preferable Example of the Organic Compound (Ab)

As a preferable example of the organic compound (Ab), a compound shown by the following formula can be given. 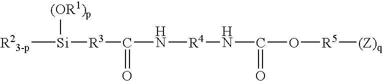
wherein R¹ and R² individually represent a hydrogen atom or an allyl group or aryl group having 1-8 carbon atoms such as a methyl group, ethyl group, propyl group, butyl group, octyl group, phenyl group, and xylyl group, and p is an integer from 1 to 3.

As examples of the group [(R¹O)ₚR²₃₋ₚSi—], a trimethoxysilyl group, triethoxysilyl group, triphenoxysilyl group, methyldimethoxysilyl group, dimethylmethoxysilyl group, and the like can be given. Of these, a trimethoxysilyl group or a triethoxysilyl group is preferable.

R³ is a divalent organic group having an aliphatic structure or an aromatic structure having 1-12 carbon atoms and may include a linear, branched, or cyclic structure.

R⁴ is a divalent organic group and is generally selected from divalent organic groups having a molecular weight of 14-10,000, and preferably 76-500.

R⁵ is an organic group with a valence of (q+1) and is preferably selected from linear, branched, and cyclic saturated and unsaturated hydrocarbon groups.

Z is a monovalent organic group having a polymerizable unsaturated group in the molecule which reacts by an intermolecular crosslinking reaction in the presence of active radicals, and q is preferably an integer from 1 to 20, more preferably from 1 to 10, and particularly preferably from 1 to 5.

The organic compound (Ab) used in the present invention may be synthesized by a method described in Japanese Patent Application Laid-open No. 9-100111, for example.

The amount of the organic compound (Ab) bonded to the oxide particles (Aa) is preferably 0.01 wt % or more, more preferably 0.1 wt % or more, and particularly preferably 1 wt % or more of 100 wt % of the reactive particles (A) (oxide particles (Aa) and organic compound (Ab) in total). If the amount of the organic compound (Ab) bonded to the oxide particles (Aa) is less than 0.01 wt %, dispersibility of the reactive particles (A) in the composition may be insufficient, whereby transparency and scratch resistance of the resulting cured product may be insufficient. The amount of the oxide particles (Aa) in the raw materials when preparing the reactive particles (A) is preferably 5-99 wt %, and still more preferably 10-98 wt %.

The amount (content) of the reactive particles (A) in the curable composition is preferably 5-90 wt %, and still more preferably 15-85 wt % of 100 wt % of the composition (the total of the reactive particles (A), compound (B) having a urethane bond, and photoinitiator (C)). If the amount is less than 5 wt %, a product with a high refractive index may not be obtained. If the amount is more than 90 wt %, film formability may be insufficient.

In this case, the content of the oxide particles (Aa) which make up the reactive particles (A) in the composition is preferably 65-90 wt %.

The amount of the reactive particles (A) refers to the solid content. In the case where the reactive particles (A) are used in the form of solvent dispersed sol, the amount of the reactive particles (A) does not include the amount of the solvent.

2. Compound (B) Having a Urethane Bond

Although there are no specific limitations to the compound (B) containing a urethane bond and two or more polymerizable unsaturated groups in the molecule used in the present invention, the compound (B) is a urethane(meth)acrylate.

Although there are no specific limitations to the urethane(meth)acrylate used as the compound (B) having a urethane bond, such a urethane(meth)acrylate is principally obtained by reacting (a) a polyisocyanate compound with (b) a hydroxyl group-containing (meth)acrylate monomer. The urethane(meth)acrylate may be a compound having an oligomer as a main chain to which urethane is bonded.

The urethane(meth)acrylate must have at least two, preferably four or more, and still more preferably six or more, (meth)acryloyl groups bonded to the oligomer main chain.

As a preferable specific example of the urethane(meth)acrylate (B) obtained by reacting a polyisocyanate compound (a) with a hydroxyl group-containing (meth)acrylate monomer (b), a compound shown by the following formula (2) can be given.
Yᵣ—R⁷—O—CO—NH—R⁶—NH—CO—O—R⁸—Yₛ (2)
wherein R⁶ is a divalent organic group which is generally selected from divalent organic groups having a molecular weight from 14 to 10,000, and preferably from 76 to 500,

R⁷ and R⁸ are organic groups with a valence respectively of (r+1) and (s+1) and are preferably selected from the group consisting of linear, branched, or cyclic saturated or unsaturated hydrocarbon groups,

Y is a monovalent organic group having a polymerizable unsaturated group in the molecule which undergoes an intermolecular crosslinking reaction in the presence of active radicals, and r and s are individually an integer from 1 to 20, more preferably from 1 to 10, and particularly preferably from 1 to 5.

R⁷ and R⁸, as well as Yᵣ and Yₛ, may be either the same or different.

The proportion of the polyisocyanate compound (a) and the hydroxyl group-containing (meth)acrylate monomer used for synthesizing the urethane(meth)acrylate is preferably determined so that the hydroxyl group included in the hydroxyl group-containing (meth)acrylate is 1.0-2 equivalents for one equivalent of the isocyanate group included in the polyisocyanate compound.

For example, the (meth)acryloyl group may be present at each end of the oligomer main chain as a reactive end group. The oligomer main chain may have polyether, polyolefin, polyester, polycarbonate, hydrocarbon, or copolymers of these compounds as a base. The oligomer main chain is preferably a polyol prepolymer such as polyether polyol, polyolefin polyol, polycarbonate polyol, or a mixture of these prepolymers. When the oligomer main chain is prepared by converting the prepolymer into a radiation curable oligomer using a method known in the aret, the molecular weight of the polyol prepolymer is preferably 46-10,000, more preferably 46-5,000, and most preferably 46-3,000.

The oligomer main chain of the urethane(meth)acrylate may be one or more oligomer blocks bonded to each other via urethane bonds, for example. For example, one or more types of polyol prepolymers may be bonded by a method known in the art. If the polyol prepolymer of the oligomer main chain is a polyether polyol, a coating with a low glass transition temperature and excellent mechanical characteristics can be obtained. If the oligomer main chain is a polyolefin polyol, a coating with exceptionally improved water resistance can be obtained. A polycarbonate oligomer can be prepared by reacting, for example, a polyisocyanate (a), a polycarbonate polyol and a hydroxyl group-containing (meth)acrylate monomer (b).

As specific examples of a method for preparing the urethane(meth)acrylate (B), a method of reacting the polyol compound (c), polyisocyanate compound (a), and hydroxyl group-containing (meth)acrylate monomer (b) all together; a method of reacting the polyol compound (c) with the polyisocyanate compound, and reacting the resulting product with the hydroxyl group-containing (meth)acrylate monomer (b); a method of reacting the polyisocyanate compound (a) with the hydroxyl group-containing (meth)acrylate (b), and reacting the resulting product with the polyol (c); a method of reacting the polyisocyanate compound (a) with the hydroxyl group-containing (meth)acrylate (b), reacting the resulting product with the polyol compound (c), and reacting the resulting product with the hydroxyl group-containing (meth)acrylate monomer (b); and the like can be given.

In the reaction of the hydroxyl group of polyol (c) with the isocyanate group, it is preferable to maintain the stoichiometric balance between the hydroxyl functional groups and the isocyanate functional groups, while controlling the reaction temperature at 25° C. or more. A substantial amount of the hydroxyl functional groups should be consumed. The mol ratio of the isocyanate and the hydroxyl group-containing (meth)acrylate monomer is 3:1-1.2:1, and preferably 2:1-1.5:1. The hydroxyl group-containing (meth)acrylate monomer bonds with the isocyanate via a urethane bond.

As examples of the polyol compound (c) used for synthesizing the urethane(meth)acrylate, polyether diol, polyester diol, polycarbonate diol, and polycaprolactone diol can be given. Of these, the polyether diol is preferable. The polyether diol may be used in combination with other diols. There are no specific limitations to the manner of polymerization of these structural units, which may be any of random polymerization, block polymerization, or graft polymerization.

As examples of the polyether diol, polyether olefin diols obtained by ring-opening polymerization of one ion-polymerizable cyclic compound such as polyethylene glycol, polypropylene glycol, polytetramethylene glycol, polyhexamethylene glycol, polyheptamethylene glycol, and polydecamethylene glycol, polyether diols obtained by ring-opening copolymerization of two or more ion-polymerizable cyclic compounds, and the like can be given. As examples of ion-polymerizable cyclic compounds, cyclic ethers such as ethylene oxide, propylene oxide, butene-1-oxide, isobutene oxide, oxetane, 3,3-dimethyloxetane, 3,3-bischloromethyloxetane, tetrahydrofuran, 2-methyltetrahydrofuran, 3-methyltetrahydrofuran, dioxane, trioxane, tetraoxane, cyclohexene oxide, styrene oxide, epichlorohydrin, glycidyl methacrylate, allyl glycidyl ether, allyl glycidyl carbonate, butadiene monoxide, isoprene monoxide, vinyloxetane, vinyltetrahydrofuran, vinylcyclohexene oxide, phenyl glycidyl ether, butyl glycidyl ether, and glycidyl benzoate can be given.

Polyether diols obtained by the ring-opening copolymerization of these ion-polymerizable cyclic compounds with cyclic imines such as ethyleneimine, cyclic lactonic acids such as γ-propyolactone or glycolic acid lactide, or dimethylcyclopolysiloxanes may be used. As specific examples of combinations of two or more ion-polymerizable cyclic compounds, combinations of tetrahydrofuran and propylene oxide, tetrahydrofuran and 2-methyltetrahydrofuran, tetrahydrofuran and 3-methyltetrahydrofuran, tetrahydrofuran and ethylene oxide, propylene oxide and ethylene oxide, butene-1-oxide and ethylene oxide, a ternary copolymer of tetrahydrofuran, butene-1-oxide, and ethylene oxide, and the like can be given. The ring-opening copolymer of these ion-polymerizable cyclic compounds may be either a random copolymer or a block copolymer.

When a polyether olefin diol is used, the polyether olefin is preferably a linear or branched hydrocarbon with two or more hydroxyl terminal groups. A large portion of the hydrocarbon may be of the methylene group (—CH₂—), whereby the polymer main chain or side chain may possess unsaturated bonds. Since the long-term stability of cured coating layers increases as the degree of unsaturation decreases, a completely saturated compound, for example, a hydrogenated hydrocarbon is preferable. As examples of the hydrocarbon diol, polymers having hydroxyl groups at the ends and completely or partially hydrogenated polymers such as 1,2-polybutadiene, 1,4- and 1,2-polybutadiene copolymer, 1,2-polybutadiene-ethylene or-propylene copolymer, polyisobutylene polyol, mixtures of these polymers can be given. As the hydrocarbon diol, almost completely hydrogenated 1,2-polybutadiene or 1,2-polybutadiene/ethylene copolymer are preferable.

When a polyether olefin diol or a polyether diol obtained by ring-opening copolymerization of two or more types of ion-polymerizable cyclic compounds is used, such a polyether diol preferably has an average of two or more hydroxyl groups. This oligomer main chain polyol may have an average of more than two hydroxyl groups. As examples of the oligomer diol, polyether diol, polyolefin diol, polyester diol, polycarbonate diol, and mixtures of these diols can be given. Polyether diol, polyolefin diol, or a combination of these diols is preferable. When polyether diol is used, it is desirable that the polyether is substantially amorphous. Such a polyether preferably contains one or more recurring units selected from the following monomer groups.

—O—CH₂—CH₂—

—O—CH₂—CH(CH₃)—

—O—CH₂—CH₂—CH₂—

—O—CH(CH₃)—CH₂—CH₂—

—O—CH₂—CH(CH₃)—CH₂—

—O—CH₂—CH₂—CH₂—CH₂—

—O—CH₂—CH(CH₃)—CH₂—CH₂—

—O—CH(CH₃)—CH₂—CH₂—CH₂—

As an example of the polyether polyol which can be used, a reaction product of 20 wt % of 3-methyltetrahydrofuran and 80 wt % of tetrahydrofuran (provided that both components have been polymerized by ring opening) can be given. This polyether copolymer has both branched oxyalkylene recurring units and unbranched oxyalkylene recurring units, and is commercially available as PTGL1000 (manufactured by Hodogaya Chemical Co., Ltd.). Another example of the polyether which can be used in this series is PTGL2000 (manufactured by Hodogaya Chemical Co., Ltd.).

Examples of commercially available products of these polyether diols include PTMG650, PTMG1000, PTMG2000 (manufactured by Mitsubishi Chemical Corp.), EXCENOL 1020, 2020, 3020, PREMINOL PML-4002, PML-5005 (manufactured by Asahi Glass Co., Ltd.), UNISAFE DC1100, DC1800, DCB1000 (manufactured by Nippon Oil and Fats Co., Ltd.), PPTG1000, PPTG2000, PPTG4000, PTG400, PTG650, PTG1000, PTG2000, PTG-L1000, PTG-L2000 (manufactured by Hodogaya Chemical Co., Ltd.), Z-3001-4, Z-3001-5, PBG2000 (manufactured by Daiichi Kogyo Seiyaku Co., Ltd.), ACCLAIM 2200, 2220, 3201, 3205, 4200, 4220, 8200, 12000 (manufactured by Lyondell), and the like can be given.

The above polyether diols are preferable as the polyol (c). In addition, polyester diols, polycarbonate diols, polycaprolactone diols, and the like may be used either individually or in combination with the polyether diols. There are no specific limitations to the manner of polymerization of these structural units, which may be any of random polymerization, block polymerization, or graft polymerization.

The examples of the polycarbonate diol include conventional polycarbonate diols produced by alcoholysis of a diethylene carbonate with a diol. These diols may be an alkylene diol having 2-12 carbon atoms such as 1,4-butanediol, 1,6-hexanediol, or 1,12-dodecane diol. A mixture of these diols can also be used. In addition to carbonate groups, the polycarbonate diol may include ether bonds in the main chain. Therefore, a polycarbonate copolymer of an alkylene oxide monomer and the above-mentioned alkylene diol, for example, can be used. As examples of the alkylene oxide monomer, ethylene oxide and tetrahydrofuran can be given. Compared with a polycarbonate homopolymer, these copolymers can produce a cured coating having low modulus and being capable of preventing crystallization of the liquid coating composition. A mixture of a polycarbonate diol and a polycarbonate copolymer can also be used.

As specific examples of the polycarbonate diol, Duracarb 122 (manufactured by PPG Industries) and Permanol KM10-1733 (manufactured by Permuthane, Massachusetts of the U.S.) can be given. Duracarb 122 is manufactured by alcoholysis of diethyl carbonate with hexanediol. As an example of the polyester diol, the reaction product of a saturated polycarboxylic acid or its anhydride and a diol can be given. Examples of the saturated polycarboxylic acid or its anhydride include phthalic acid, isophthalic acid, terephthalic acid, trimellitic acid, tetrahydrophthalic acid, hexahydrophthalic acid, tetrachlorophthalic acid, adipic acid, azelaic acid, sebacic acid, succinic acid, glutaric acid, malonic acid, pimelic acid, suberic acid, 2,2-dimethylsuccinic acid, 3,3-dimethylglutaric acid, 2,2-dimethylglutaric acid, anhydrides of these acids, and mixtures of these acids. As examples of the diol, 1,4-butanediol, 1,8-octane diol, diethylene glycol, 1,6-hexanediol, and dimethylol cyclohexane can be given. Polycaprolactones are included in this classification and are commercially available from Union Carbide Corp. as Tone Polylol series products such as Tone 0200, 0221, 0301, 0310, 2201, and 2221, for example. Tone 0301 and Tone 0310 are three-functional compounds.

As examples of the polyisocyanate (a) used for synthesizing the urethane(meth)acrylate, aromatic diisocyanates, alicyclic diisocyanates, aliphatic diisocyanates, and the like can be given. There are no specific limitations to the polyisocyanate (a) insofar as the compound can be used as a photocurable resin composition. Of these, aromatic diisocyanates and alicyclic diisocyanates are preferable, with 2,4-tolylene diisocyanate and isophorone diisocyanate being more preferable. These diisocyanates can be used either individually or in combination of two or more.

Any polyisocyanate (a) can be used either independently or as a mixture as the polyisocyanate. In this manner, an end-capped product in which at least one end of the molecule is capped with the reaction product obtained from the reaction of isocyanate and (meth)acrylate monomer. “End-cap” herein indicates an addition reaction of a functional group to one of the ends of an oligomer diol. The reaction product of isocyanate and hydroxyl group-containing (meth)acrylate monomer bonds with the oligomer main chain diol (c) via a urethane bond. The urethanization reaction is carried out in the presence of a catalyst. As examples of the catalyst for the urethanization reaction, dibutyl tindilaurate and diazabicyclo octane crystals can be given.

Examples of the polyisocyanate compound (a) used for the synthesis of urethane(meth)acrylate include isophorone diisocyanate (IPDI), tetramethyl xylene diisocyanate (TMXDI), toluene diisocyanate (TDI), diphenyl methylene diisocyanate, hexamethylene diisocyanate, cyclohexylene diisocyanate, methylene dicyclohexane diisocyanate, 2,2,4-trimethylhexamethylene diisocyanate, m-phenylene diisocyanate, 4-chloro-1,3-phenylene diisocyanate, 4,4′-biphenylene diisocyanate, 1,5-naphthylene diisocyanate, 1,4-tetramethylene diisocyanate, 1,6-hexamethylene diisocyanate, 1,10-decamethylene diisocyanate, 1,4-cyclohexylene diisocyanate, and a compound with a diisocyanate such as toluene diisocyanate bonded to both terminals of a polyalkylene oxide or polyester glycol. For example, polytetramethylene ether glycol with a TDI terminal and polyethylene adipate with a TDI terminal can be given. Of these diisocyanates, isophorone diisocyanate and toluene diisocyanate are preferable.

As the hydroxyl group-containing (meth)acrylate monomer (b) used for synthesizing the urethane(meth)acrylate, a hydroxyl group-containing (meth)acrylate monomer in which the hydroxyl group is bonded to the primary carbon atom (hereinafter called “primary hydroxyl group-containing (meth)acrylate”) and a hydroxyl group-containing (meth)acrylate in which the hydroxyl group is bonded to the secondary carbon atom (hereinafter called “secondary hydroxyl group-containing (meth)acrylate”) are preferable in view of reactivity with an isocyanate group of the polyisocyanate.

Generally, the hydroxyl group-containing (meth)acrylate monomer (b) has a functional group polymerizable with radiation and a functional group reactive with diisocyanate.

As examples of the primary hydroxyl group-containing (meth)acrylate, 2-hydroxyethyl(meth)acrylate, 4-hydroxybutyl(meth)acrylate, 1,6-hexanediol mono(meth)acrylate, pentaerythritol tri(meth)acrylate, dipentaerythritol penta(meth)acrylate, neopentyl glycol mono(meth)acrylate, trimethylolpropane di(meth)acrylate, trimethylolethane di(meth)acrylate, and the like can be given.

As examples of the secondary hydroxyl group-containing (meth)acrylate, 2-hydroxypropyl(meth)acrylate, 2-hydroxybutyl(meth)acrylate, 2-hydroxy-3-phenyloxypropyl(meth)acrylate, 4-hydroxycyclohexyl(meth)acrylate, and the like can be given. Further examples include a compound obtained by the addition reaction of (meth)acrylic acid and a glycidyl group-containing compound such as alkyl glycidyl ether, allyl glycidyl ether, or glycidyl(meth)acrylate, and the like. These hydroxyl group-containing (meth)acrylate monomer may be used either individually or in combination of two or more.

The proportion of the polyol (c), polyisocyanate compound (a), and hydroxyl group-containing (meth)acrylate monomer (b) used for synthesizing the urethane(meth)acrylate is preferably determined so that the isocyanate group included in the polyisocyanate compound (a) and the hydroxyl group included in the hydroxyl group-containing (meth)acrylate are respectively 1.1-2 equivalents and 0.1-1 equivalent for one equivalent of the hydroxyl group included in the polyol compound (c).

In addition, a diamine compound (d) may be used for synthesizing the urethane(meth)acrylate in combination with the polyol (c). As examples of the diamine (d), diamines such as ethylenediamine, tetramethylenediamine, hexamethylenediamine, p-phenylenediamine, and 4,4′-diaminodiphenylmethane, diamines containing a hetero atom, polyether diamines, and the like can be given.

In the synthesis of the urethane(meth)acrylate, it is preferable to use a urethanization catalyst such as copper naphthenate, cobalt naphthenate, zinc naphthenate, dibutyltin dilaurate, triethylamine, 1,4-diazabicyclo[2.2.2]octane, or 2,6,7-trimethyl-1,4-diazabicyclo[2.2.2]octane in an amount of 0.01-1 wt % of the total amount of the reactants. The reaction temperature is usually 5-90° C., and preferably 10-80° C.

The urethane(meth)acrylate used in the present invention includes commercially available products in addition to the compounds synthesized as described above. As examples of commercially available products of urethane(meth)acrylate, BEAMSET 102, 502H, 505A-6, 510, 550B, 551B, 575, 575CB, EM-90, EM92, manufactured by Arakawa Chemical Industries, Ltd.; PHOTOMER 6008 and 6210, manufactured by SAN NOPCO, Ltd.; NK OLIGO U-2PPA, U-4HA, U-6HA, H-15HA, UA-32PA, U-324A, U-4H, and U-6H, manufactured by Shin-Nakamura Chemical Co., Ltd.; Aronix M-1100, M-1200, M-1210, M-1310, M-1600, and M-1960, manufactured by Toagosei Co., Ltd.; AH-600, AT606, and UA-306H, manufactured by Kyoeisha Chemical Co., Ltd.; Kayarad UX-2201, UX-2301, UX-3204, UX-3301, UX-4101, UX-6101, and UX-7101, manufactured by Nippon Kayaku Co., Ltd.; UV-1700B, UV-3000B, UV-6100B, UV-6300B, UV-7000, and UV-2010B, manufactured by Nippon Synthetic Chemical Industry Co., Ltd.; Artresin UN-1255, UN-5200, HDP-4T, HMP-2, UN-901T, UN-3320HA, UN-3320HB, UN-3320HC, UN-3320HS, H-61, and HDP-M20, manufactured by Negami Chemical Industrial Co., Ltd.; Ebecryl 6700, 204, 205, 220, 254, 1259, 1290K, 1748, 2002, 2220, 4833, 4842, 4866, 5129, 6602, and 8301, manufactured by DAICEL UBC CO LTD.; and the like can be given.

The amount of the compound (B) having a urethane bond used in the present invention is preferably 1-90 wt %, and still more preferably 5-90 wt % for 100 wt % of the composition (the total of the reactive particles (A), compound (B) having a urethane bond, and photoinitiator (C)). If the amount is less than 5 wt % or exceeds 90 wt %, not only may the resulting cured product not have sufficient hardness, but also adhesiveness of the coating film may decrease.

As required, a later-described compound (D) having two or more polymerizable unsaturated groups in the molecule may be used in the composition of the present invention in addition to the compound (B) having a urethane bond.

3. Photoinitiator (C)

In addition to the reactive particles (A) and the compound (B) having a urethane bond, a photoinitiator (C) is added to the composition of the present invention.

As the photoinitiator (C), commonly used photoinitiators such as a compound which generates cation species with irradiation of radioactive rays (light), a compound which generates active radicals by irradiation of radioactive rays (lights) (a radical (photo) polymerization initiator), and the like can be given as examples.

As a preferable example of the compound which generates cation species upon irradiation, an onium salt having a structure shown by the following formula (3) can be given.

The onium salt generates a Lewis acid upon exposure to light.
[R⁹ₐR¹⁰_{b}R¹¹_{c}R¹²_{d}W]^{+e}[ML_{e+f}]^{-e} (3)
wherein a cation is an onium ion; W is S, Se, Te, P, As, Sb, Bi, O, I, Br, Cl, or —N≡N; R⁹, R¹⁰, R¹¹, and R¹² are the same or different organic groups; a, b, c, and d are individually integers from 0 to 3, provided that (a+b+c+d) is equal to the valence of W; M is a metal or a metalloid which constitutes a center atom of the halide complex [ML_{e+f}] such as B, P, As, Sb, Fe, Sn, Bi, Al, Ca, In, Ti, Zn, Sc, V, Cr, Mn, and Co; L is a halogen atom such as F, Cl, and Br; e is a positive charge of a halide complex ion; and f is a valence of M.

As specific examples of the anion [ML_{e+f}] in the formula (3), tetrafluoroborate (BF₄⁻), hexafluorophosphate (PF₆⁻), hexafluoroantimonate (SbF₆⁻), hexafluoroarsenate (AsF₆⁻), hexachloroantimonate (SbCl₆⁻), and the like can be given.

An onium salt having an anion of the formula [ML_{f}(OH)⁻] may also be used. Onium salts having other anions such as a perchloric acid ion (ClO₄⁻), trifluoromethanesulfonic acid ion (CF₃SO₃⁻), fluorosulfonic acid ion (FSO₃⁻), toluenesulfonic acid ion, trinitrobenzenesulfonic acid anion, and trinitrotoluenesulfonic acid anion may be used.

Of these onium salts, aromatic onium salts are particularly preferable as the photoinitiator (C). Among the aromatic onium salts, aromatic halonium salts disclosed in Japanese Patent Applications Laid-open No. 50-151996 and No. 50-158680, VIA group aromatic onium salts disclosed in Japanese Patent Applications Laid-open No. 50-151997, No. 52-30899, No. 56-55420, and No. 55-125105; VA group aromatic onium salts disclosed in Japanese Patent Application Laid-open No. 50-158698; oxosulfoxonium salts disclosed in Japanese Patent Applications Laid-open No. 56-8428, No. 56-149402, and No. 57-192429; aromatic diazonium salts disclosed in Japanese Patent Application Laid-open No. 49-17040; thiopyrylium salts disclosed in U.S. Pat. No. 4,139,655; and the like are preferable. In addition, iron/allene complex initiators, aluminum complex/photolysis silicon compound initiators, and the like may also be used.

These onium salts may be used either individually or in combination of two or more.

As examples of commercially available products suitably used as the photoinitiator (C), Catalyst 4050 (manufactured by Mitsui-Cytec, Ltd.), UVI-6950, UVI-6970, UVI-6974, UVI-6990 (manufactured by Union Carbide), Adekaoptomer SP-150, SP-151, SP-170, SP-171 (manufactured by Asahi Denka Co., Ltd.), Irgacure 261 (manufactured by Ciba Specialty Chemicals Inc.), CI-2481, CI-2624, CI-2639, CI-2064 (manufactured by Nippon Soda Co., Ltd.), CD-1010, CD-1011, CD-1012 (manufactured by Sartomer Company Inc.), DTS-102, DTS-103, NAT-103, NDS-103, TPS-103, MDS-103, MPI-103, BBI-103 (manufactured by Midori Kagaku Co., Ltd.), PCI-061T, PCI-062T, PCI-020T, PCI-022T (manufactured by Nippon Kayaku Co., Ltd.), and the like can be given. Of these, Catalyst 4050 (manufactured by Mitsui Cytec, Ltd.), UVI-6970, UVI-6974, UVI-6990, Adekaoptomer SP-150, SP-170, SP-171, CD-1012, and MPI-103 are preferable, because the resulting curable composition is provided with excellent surface curability.

There are no specific limitations to the radiation (photo) polymerization initiator insofar as such an initiator decomposes upon irradiation and generates radicals to initiate polymerization. Examples of such an initiator include acetophenone, acetophenone benzyl ketal, 1-hydroxycyclohexyl phenyl ketone, 2,2-dimethoxy-1,2-diphenylethan-1-one, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholino-propan-1-one, 2-benzyl-2-dimethylamino-1-(4-morpholinophenyl)-butanone-1,4-(2-hydroxyethoxy)phenyl-(2 -hydroxy-2-propyl)ketone, 2,4,6-trimethylbenzoyl diphenylphosphine oxide, bis-(2,6-dimethoxybenzoyl)-2,4,4-trimethylpentylphosphine oxide, and oligo(2-hydroxy-2-methyl-1-(4-(1-methylvinyl)phenyl)propanone).

As examples of commercially available products of radical(photo)polymerization initiator, Irgacure 184, 369, 651, 500, 819, 907, 784, 2959, CGI1700, CGI1750, CGI1850, CG24-61, Darocur 1116, 1173 (manufactured by Ciba Specialty Chemicals Co., Ltd.), Lucirin TPO (manufactured by BASF), Ubecryl P36 (manufactured by UCB), and Esacure KIP150, KIP65LT, KIP100F, KT37, KT55, KT046, KIP75/B (manufactured by Lamberti), and the like can be given.

The composition of the present invention may be cured using the photopolymerization initiator and the heat polymerization initiator in combination, as required.

As preferable examples of the heat polymerization initiator, peroxides and azo compounds can be given. Specific examples include benzoyl peroxide, t-butyl peroxybenzoate, and azobisisobutyronitrile.

The amount of the photoinitiator (C) used in the present invention is 0.01-20 wt %, and preferably from 0.1-10 wt %, for 100 wt % of the composition (the total of the reactive particles (A), the compound (B) having a urethane bond, and the photoinitiator (C)). If the amount is less than 0.01 wt %, film formability may be insufficient. If the amount exceeds 20 wt %, a cured product with high hardness may not be obtained.

4. Compound (D)

A compound which is optionally used in the present invention is a compound having two or more polymerizable unsaturated groups in the molecule, excluding the component (B) (hereinafter referred to as “compound (D)” or component (D)). The compound (D) is suitable for increasing film-formability of the composition. There are no specific limitations to the compound (D) insofar as the compound has at least two polymerizable unsaturated groups in the molecule. As examples of the compound (D), melamine acrylates, (meth)acrylates, vinyl compounds, and the like can be given. Of these, (meth)acrylates are preferable.

The following compounds can be given as specific examples of the compound (D) used in the present invention.

As examples of (meth)acrylates, trimethylolpropane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, dipentaerythritol hexa(meth)acrylate, glycerol tri(meth)acrylate, tris(2-hydroxyethyl)isocyanurate tri(meth)acrylate, ethylene glycol di(meth)acrylate, 1,3-butanediol di(meth)acrylate, 1,4-butanediol di(meth)acrylate, 1,6-hexanediol di(meth)acrylate, neopentyl glycol di(meth)acrylate, diethylene glycol di(meth)acrylate, triethylene glycol di(meth)acrylate, dipropylene glycol di(meth)acrylate, bis(2-hydroxyethyl)isocyanurate di(meth)acrylate, poly(meth)acrylates of ethylene oxide or propylene oxide addition product of starting alcohols of these (meth)acrylates, oligoester(meth)acrylates, oligoether(meth)acrylates, oligourethane(meth)acrylates, and oligoepoxy(meth)acrylates having two or more (meth)acryloyl groups in the molecule, and the like can be given. Of these, dipentaerythritol hexa(meth)acrylate, dipentaerythritol penta(meth)acrylate, pentaerythritol tetra(meth)acrylate, and ditrimethylolpropane tetra(meth)acrylate are preferable.

As vinyl compounds, divinylbenzene, ethylene glycol divinyl ether, diethylene glycol divinyl ether, triethylene glycol divinyl ether, and the like can be given.

As examples of commercially available products of the compound (D), Nikalac MX-302 (manufactured by Sanwa Chemical Co., Ltd.), Aronix M-400, M-408, M-450, M-305, M-309, M-310, M-315, M-320, M-350, M-360, M-208, M-210, M-215, M-220, M-225, M-233, M-240, M-245, M-260, M-270, M-1100, M-1200, M-1210, M-1310, M-1600, M-221, M-203, TO-924, TO-1270, TO-1231, TO-595, TO-756, TO-1343, TO-902, TO-904, TO-905, TO-1330 (manufactured by Toagosei Co., Ltd.); KAYARAD D-310, D-330, DPHA, DPCA-20, DPCA-30, DPCA-60, DPCA-120, DN-0075, DN-2475, SR-295, SR-355, SR-399E, SR-494, SR-9041, SR-368, SR-415, SR-444, SR-454, SR-492, SR-499, SR-502, SR-9020, SR-9035, SR-111, SR-212, SR-213, SR-230, SR-259, SR-268, SR-272, SR-344, SR-349, SR-601, SR-602, SR-610, SR-9003, PET-30, T-1420, GPO-303, TC-120S, HDDA, NPGDA, TPGDA, PEG400DA, MANDA, HX-220, HX-620, R-551, R-712, R-167, R-526, R-551, R-712, R-604, R-684, TMPTA, THE-330, TPA-320, TPA-330, KS-HDDA, KS-TPGDA, KS-TMPTA (manufactured by Nippon Kayaku Co., Ltd.); Light-Acrylate PE-4A, DPE-6A, DTMP-4A (manufactured by Kyoeisha Chemical Co., Ltd.); and the like can be given.

The amount (content) of the compound (D), which is optionally used in the present invention, is preferably 0-80 wt %, and still more preferably 0-50 wt % for 100 wt % of the composition (the total of the reactive particles (A), compound (B) having a urethane bond, and photoinitiator (C)).

5. Other Components

The curable composition of the present invention may include additives such as a photosensitizer, polymerization inhibitor, polymerization adjuvant, leveling agent, wettability improver, surfactant, plasticizer, UV absorber, antioxidant, antistatic agent, inorganic filler, pigment, dye, and the like insofar as the effects of the present invention are not impaired.

Although the composition of the present invention comprises the photoinitiator (C) as the polymerization initiator, a heat polymerization initiator such as a compound which thermally generates cation species and/or a compound which thermally generates active radicals may be added in addition to the photoinitiator.

As examples of the compound which thermally generates cation species, an aliphatic sulfonic acid, aliphatic sulfonate, aliphatic carboxylic acid, aliphatic carboxylate, aromatic carboxylic acid, aromatic carboxylate, alkylbenzene sulfonic acid, alkylbenzene sulfonate, phosphate, metal salt, and the like can be given.

These onium salts may be used either individually or in combination of two or more.

As preferable examples of the heat polymerization initiator, peroxides and azo compounds can be given. Specific examples include benzoyl peroxide, t-butyl peroxybenzoate, and azobisisobutyronitrile.

The amount of the radical polymerization initiator optionally used in the present invention is preferably 0.01-20 parts by weight, and still more preferably 0.1-10 parts by weight for 100 parts by weight of the composition (the total of the reactive particles (A), compound (B) having a urethane bond, and photoinitiator (C)). If the amount is less than 0.01 part by weight, hardness of the cured product may be insufficient. If the amount exceeds 20 parts by weight, the inside (inner layer) of the cured product may remain uncured.

6. Application (Coating) Method of Composition

The composition of the present invention is suitable as an antireflection film or a coating material. As examples of substrates to which the composition is applied, plastics (polycarbonate, polymethacrylate, polystyrene, polyester, polyolefin, epoxy resin, melamine resin, triacetyl cellulose resin, ABS resin, AS resin, norbornene resin, etc.), metals, wood, paper, glass, and slates can be given. The substrate may be in the shape of a plate, a film, or a three-dimensional formed product. As the coating method, a conventional coating method such as dipping, spray coating, flow coating, shower coating, roll coating, spin coating, brush coating, or the like can be given. The thickness of the film after drying and curing is usually 0.01-400 ìm, and preferably 0.1-200 ìm.

In order to adjust the thickness of the coating, the composition of the present invention may be used after diluting the composition with a solvent. In the case where the composition is used as an antireflection film or a coating material, the viscosity of the composition is usually 0.1-50,000 mPa·s/25° C., and preferably 0.5-10,000 mPa·s/25° C.

As examples of solvents used for adjusting the film thickness, alcohols such as methanol, ethanol, isopropanol, butanol, and octanol; ketones such as acetone, methyl ethyl ketone, methyl isobutyl ketone, and cyclohexanone; esters such as ethyl acetate, butyl acetate, ethyl lactate, γ-butyrolactone, propylene glycol monomethyl ether acetate, and propylene glycol monoethyl ether acetate; ethers such as ethylene glycol monomethyl ether and diethylene glycol monobutyl ether; aromatic hydrocarbons such as benzene, toluene, and xylene; amides such as dimethylformamide, dimethylacetamide, and N-methylpyrrolidone; and the like can be given. Although there are no specific limitations to the amount of the solvent used in the present invention, the solvent is usually used in an amount of 5-100,000 parts by weight, and preferably 10-10,000 parts by weight, for 100 parts by weight of the composition.

7. Curing Method of Composition

The composition of the present invention is cured by applying heat and/or radiation (light). In the case of curing the composition by applying heat, an electric heater, infrared lamp, hot blast, and the like may be used as the heat source. In the case of curing the composition by applying radiation (light), there are no specific limitations to the radiation source insofar as the composition can be cured in a short period of time after application. As examples of the source of infrared rays, a lamp, resistance heating plate, laser, and the like can be given. As examples of the source of visible rays, sunlight, a lamp, fluorescent lamp, laser, and the like can be given. As examples of the source of ultraviolet rays, a mercury lamp, halide lamp, laser, and the like can be given. As examples of the source of electron beams, a system utilizing thermoelectrons generated from a commercially available tungsten filament, a cold cathode method which generates electron beams by applying a high voltage pulse through a metal, and a secondary electron method which utilizes secondary electrons generated by collision between ionized gaseous molecules and a metal electrode can be given. As examples of the source of α-rays, β-rays, and γ-rays, fissionable substances such as Co⁶⁰ and the like can be given. As the source of γ-rays, a vacuum tube which causes accelerated electrons to collide with an anode or the like may be utilized. Either one type or a combination of two or more types of radiation may be used. In the latter case, two or more types of radiation may be applied either simultaneously or at a specific interval of time.

II. Cured Product

The cured product of the present invention may be obtained by applying the curable composition to various types of substrates such as a plastic substrate and curing the composition. Specifically, the composition is applied to a substrate, volatile components are preferably dried at a temperature of 0-200° C., and the composition is cured by applying heat and/or radiation to obtain a coating formed product. In the case of curing the composition by applying heat, the composition is preferably cured at 20 to 150° C. for 10 seconds to 24 hours. In the case of curing the composition by applying radiation, use of ultraviolet rays or electron beams is preferable. In this case, the dose of ultraviolet rays is preferably 0.01-10 J/cm², and still more preferably 0.1-2 J/cm². Irradiation conditions for electron beams are preferably at an accelerated voltage of 10-300 KV, an electron density of 0.02-0.30 mA/cm², and a dose of 1-10 Mrad.

Since the cured product of the present invention has high hardness and high refractive index and is capable of forming a coat (film) excelling in scratch resistance and adhesion to a substrate and a low-refractive-index layer, the cured product is particularly suitable as a hard coat or an antireflection film for film-type liquid crystal elements, touch panels, plastic optical parts, and the like.

Moreover, since the cured products of the present invention possess excellent antistatic characteristics, they are also useful as antistatic films for various plastic optical parts and the like.

III. Laminate

The laminate of the present invention is formed by layering a high-refractive-index cured film obtained by curing the curable composition and a low-refractive-index film on a substrate in that order. The laminate is particularly suitable as an antireflection film.

There are no specific limitations to the substrate used for the laminate of the present invention. In the case of using the laminate as an antireflection film, substrates made of plastic (polycarbonate, polymethylmethacrylate, polystyrene, polyester, polyolefin, epoxy resin, melamine resin, triacetyl cellulose resin, ABS resin, AS resin, norbornene resin, and the like) can be given.

As examples of the low-refractive-index film used in the present invention, a metal oxide film made of magnesium fluoride or silicon dioxide, a fluorine-type coat material cured film, and the like having a refractive index of 1.38-1.45 can be given.

Another film may be present between the high-refractive-index cured film and the low-refractive-index film or between the substrate and the high-refractive-index cured film. For example, a hard coat layer or a reflection preventive layer may be provided between the substrate and the high-refractive-index cured film.

As a method for forming the low-refractive-index film on the high-refractive-index cured film obtained by curing the curable composition, in the case of forming a metal oxide film, vacuum deposition, sputtering, and the like can be given. In the case of forming a fluorine-type coat material cured film, a method the same as the application (coating) method of the composition can be given.

Reflection of light on the surface of the substrate can be effectively prevented by layering the high-refractive-index cured film and the low-refractive-index film on the substrate.

The laminate of the present invention is particularly suitable as an antireflection film, hard coat, and antistatic film for film-type liquid crystal elements, touch panels, plastic optical parts, and the like, since the laminate has a low reflectance and excels in antistatic performance.

### EXAMPLES

The present invention is described below in detail by examples, which should not be construed as limiting the present invention. In the examples, “part(s)” refers to “part(s) by weight” and “%” refers to “wt %” unless otherwise indicated.

Preparation of Reactive Particles (A)

### Preparation Example 1

### Preparation of Oxide Particles (Aa)

300 parts of spherical ATO fine particles (manufactured by Ishihara Techno Corp, number average primary particle diameter: 0.01 μm) were added to 700 parts of methanol and dispersed for 168 hours using glass beads. The glass beads were removed to obtain 950 parts of methanol ATO sol (Aa). 2 g of the dispersion sol was weighed in an aluminum dish and dried at 120° C. for one hour on a hot plate. The dried product was weighed to indicate that the solid content was 30%.

### Preparation Example 2

### Preparation of Organic Compound (Ab) Having a Polymerizable Unsaturated Group

20.6 parts of isophorone diisocyanate were added dropwise to 7.8 parts of mercaptopropyltrimethoxysilane and 0.2 part of dibutyltin dilaurate in a vessel equipped with a stirrer at 50° C. for one hour in dry air. The mixture was stirred at 60° C. for three hours.

After the addition of 71.4 parts of pentaerythritol triacrylate dropwise at 30° C. for one hour, the mixture was stirred at 60° C. for three hours to obtain a reaction solution.

The residual isocyanate content in the reaction product (organic compound (Ab) having a polymerizable unsaturated group) in the reaction solution was analyzed by FT-IR and found to be 0.1 wt % or less. This indicates that each reaction was completed almost quantitatively. The organic compound had a thiourethane bond, urethane bond, alkoxysilyl group, and acryloyl group (polymerizable unsaturated group) in the molecule.

### Preparation Example 3

### Preparation of Reactive ATO Fine Particle Sol (Component (A))

A mixture of 7.6 parts of the organic compound (Ab) having a polymerizable unsaturated group prepared in Preparation Example 2, 306.2 parts of methanol ATO sol (Aa) (ATO concentration: 30%) prepared in Preparation Example 1, 0.1 part of ion-exchanged water, and 0.01 part of p-hydroxyphenyl monomethyl ether was stirred at 60° C. for three hours. After the addition of 1.3 parts of methyl orthoformate, the mixture was stirred for one hour at the same temperature to obtain reactive particles (reactive ATO fine particle sol). 2 g of the reactive ATO fine particle sol (A) was weighed on an aluminum dish and dried for one hour on a hot plate at 120° C. The weight of the dried material was determined to confirm that the solid content was 31%. 2 g of a dispersion of the reactive ATO fine particle sol (A) was weighed in a magnetic crucible, preliminarily dried for 30 minutes on a hot plate at 80° C., and incinerated for one hour in a muffle furnace at 750° C. The content of inorganic components in the solid components was determined from the resulting inorganic residue to confirm that the content of inorganic components was 90%.

Preparation of Curable Compositions

### Example 1

195.2 parts of the reactive ATO fine particle sol prepared in Preparation Example 3 (component (A)), consisting of 60.5 parts of the reactive ATO and 134.7 parts of methanol, 36.6 parts of urethane acrylate compound (PETA-IPDI-PETA; component (B)), 2.9 parts of Irgacure 907 (component (C)), 96.7 parts of methanol (MeOH), and 1668.6 parts of propylene glycol monomethyl ether (PGME) were stirred for two hours at 30° C. to obtain a composition in the form of a homogeneous solution. The solid content of the composition determined in the same manner as in the Preparation Example 3 was 5%.

### Examples 2-9 and Comparative Examples 1-3

Compositions of Examples 2-9 and Comparative Examples 1-3 were prepared in the same manner as in Example 1 except for using the components shown in Table 1.

Preparation of Laminates

Preparation of Coating Liquid A

The method of manufacturing the coating liquid A (high refractive index curable composition consisting of reactive zirconia fine particle sol, acrylics monomer, melamine, photoinitiator, and solvent) used for preparing the laminations are given in Preparation Examples 4-6.

### Preparation Example 4

### Preparation of Methyl Ethyl Ketone Zirconia Sol

300 parts of fine spherical zirconia particles (manufactured by Sumitomo Osaka Cement Co., Ltd., number average primary particle diameter: 0.01 μm) were added to 700 parts of methyl ethyl ketone (MEK) and dispersed for 168 hours using glass beads. The glass beads were removed to obtain 950 parts of methyl ethyl ketone zirconia sol. 2 g of the dispersion sol was weighed in an aluminum dish and dried at 120° C. for one hour on a hot plate. The dried product was weighed to indicate that the solid content was 30%. As a result of electron microscope observation of the solid product, the minor axis average particle diameter was 15 nm, the major axis average particle diameter was 20 nm, and the aspect ratio was 1.3.

### Preparation Example 5

### Preparation of Reactive Zirconia Fine Particle Sol

A mixture of 5.2 parts of the organic compound having a polymerizable unsaturated group prepared in Preparation Example 2, 237 parts of methyl ethyl ketone zirconia sol (zirconia content: 30%) prepared in Preparation Example 4, 0.1 part of ion-exchanged water, and 0.03 part of p-hydroxyphenyl monomethyl ether was stirred at 60° C. for three hours. After the addition of 1.0 part of methyl orthoformate, the mixture was stirred for one hour at the same temperature to obtain reactive zirconia fine particle sol. 2 g of the reactive zirconia fine particle sol was weighed on an aluminum dish and dried for one hour over a hot plate at 120° C. The weight of the dried material was determined to confirm that the solid content was 31%. 2 g of the reactive zirconia fine particle sol was weighed in a magnetic crucible, preliminarily dried at 80° C. for 30 minutes on a hot plate, and incinerated at 750° C. for one hour in a muffle furnace. The content of inorganic components in the solid components was determined from the resulting inorganic residue to confirm that the content of inorganic components was 93%.

### Preparation Example 6

### Preparation of Coating Liquid A

227.9 parts of the reactive zirconia fine particle sol prepared in the Preparation Example 5 (reactive zirconia: 80.9 parts), 10.0 parts of dipentaerythritol pentacrylate (“KAYARAD DPHA-2C” manufactured by Nippon Kayaku Co., Ltd.), 2.5 parts of 1-hydroxycyclohexyl phenyl ketone, 1.5 parts of 2-methyl-1-[4-(methylthio)phenyl]-2-morpholinopropane-1, and 233.4 parts of xylene were mixed in a UV shielding vessel. The mixture was condensed using a rotary evaporator until the solid content was 46.7%. After adding 5.1 parts of a melamine compound (Cymel 238, manufactured by PSI Tech Industries) to the resulting concentrate, the mixture was stirred at 30° C. for two hours to obtain a composition in the form of a homogeneous solution. The solid content of the composition determined in the same manner as in the Preparation Example 3 was 48%.

Preparation of Laminate

Each of the compositions obtained in Examples 1-9 and Comparative Examples 1-3 was applied to a TAC film (thickness: 80 μm) using a coater fitted with a wire bar coater (#6) conforming to the thickness of the coat to be produced and dried at 80° C. for three minutes in an oven to form a coat. The coat was cured by irradiation of UV rays at a dose of 0.3 J/cm² using a metal halide lamp in air to obtain a cured film with a thickness of 0.1 ìm.

The coating liquid (A) prepared in Preparation Example 6 was applied onto the resulting cured film using a wire bar coater (#6) and dried at 80° C. for three minutes in an oven to form a coating. The coat was cured by irradiation of UV rays at a dose of 0.3 J/cm² using a metal halide lamp in air to form a cured film with a thickness of 3 mm, thereby obtaining a laminate.

Evaluation of Laminate

1. Transparency (Haze)

The haze value (%) of the test specimens was measured using a color haze meter (manufactured by Suga Seisakusho, Co., Ltd.) according to ASTM D1003. The haze value including the substrate film was evaluated.

2. Adhesion (Cross-Cut Peeling Test)

The obtained laminate was cut into a total of 100 (10×10) squares, 1 mm×1 mm each, using a cross cut guide according to JIS K5400. Cellophane tape was caused to adhere to the cross-cut laminate and then peeled to count the released squares. The results were indicated as the number of unpeeled squares/100, e.g. 100/100, if no square was peeled, and 0/100, if all squares were peeled.

3. Antistatic Performance

The antistatic performance was measured using Hiresta UP MCT-HT450, manufactured by Mitsubishi Chemical Corp., by attaching the coated side of the laminate to the electrode side of the instrument and applying a voltage of 100V.

TABLE 1

| Composition of curable | | Examples | | | | | |
|---|---|---|---|---|---|---|---|
| compound | | 1 | 2 | 3 | 4 | 5 | 6 |
| Component (A) | Reactive ATO fine | 60.5 | 60.5 | 60.5 | 60.5 | 60.5 | 60.5 |
| | particle sol | | | | | | |
| Component (B) | PETA-IPDI-PETA | 36.6 | | | | | |
| | PETA-TDI-PETA | | 36.6 | | | | |
| | HEA-IPDI-HEA | | | 36.6 | | | |
| | HEA-TDI-HEA | | | | 36.6 | | |
| | U-15HA | | | | | 36.6 | 18.3 |
| | U-6HA | | | | | | |
| | U-6LPA | | | | | | |
| | U-324A | | | | | | |
| Component (C) | Irgacure 907 | 2.9 | 2.9 | 2.9 | 2.9 | 2.9 | 2.9 |
| Component (D) | DPHA | | | | | | |
| | PETA | | | | | | 18.3 |
| | TMPTA | | | | | | |
| Organic | MeOH | 231.4 | 231.4 | 231.4 | 231.4 | 231.4 | 231.4 |
| solvent | PGME | 1668.6 | 1668.6 | 1668.6 | 1668.6 | 1668.6 | 1668.6 |
| Total | | 2000 | 2000 | 2000 | 2000 | 2000 | 2000 |
| Solid content | | 5% | 5% | 5% | 5% | 5% | 5% |
| | | | | | Comparative | | |
| Composition of curable | | Examples | | | Examples | | |
| compound | | 7 | 8 | 9 | 1 | 2 | 3 |
| Component (A) | Reactive ATO fine | 60.5 | 60.5 | 60.5 | 60.5 | 60.5 | 60.5 |
| | particle sol | | | | | | |
| Component (B) | PETA-IPDI-PETA | | | | | | |
| | PETA-TDI-PETA | | | | | | |
| | HEA-IPDI-HEA | | | | | | |
| | HEA-TDI-HEA | | | | | | |
| | U-15HA | | | | | | |
| | U-6HA | 36.6 | | | | | |
| | U-6LPA | | 36.6 | | | | |
| | U-324A | | | 36.6 | | | |
| Component (C) | Irgacure 907 | 2.9 | 2.9 | 2.9 | 2.9 | 2.9 | 2.9 |
| Component (D) | DPHA | | | | 36.6 | | |
| | PETA | | | | | 36.6 | |
| | TMPTA | | | | | | 36.6 |
| Organic | MeOH | 231.4 | 231.4 | 231.4 | 231.4 | 231.4 | 231.4 |
| solvent | PGME | 1668.6 | 1668.6 | 1668.6 | 1668.6 | 1668.6 | 1668.6 |

| | | | | | | |
|---|---|---|---|---|---|---|
| Total | 2000 | 2000 | 2000 | 2000 | 2000 | 2000 |
| Solid content | 5% | 5% | 5% | 5% | 5% | 5% |

| | | Example | | | | | |
|---|---|---|---|---|---|---|---|
| Evaluation of laminate | | 10 | 11 | 12 | 13 | 14 | 15 |
| Haze | ASTM | 0.24 | 0.25 | 0.24 | 0.26 | 0.3 | 0.27 |
| | D1003 | | | | | | |
| Adhesion | Cross-cut | 100/100 | 100/100 | 76/100 | 70/100 | 100/100 | 76/100 |
| | peeling | | | | | | |
| | test | | | | | | |
| Antistatic | Surface | 4.1 × 10¹¹ | 5.4 × 10¹¹ | 1.5 × 10⁹ | 1.5 × 10⁹ | 4.7 × 10¹⁰ | 5.4 × 10⁹ |
| perfor- | resistivity | | | | | | |
| mance | (Ω/ | | | | | | |
| | | | | | Comparative | | |
| | | Example | | | Example | | |
| Evaluation of laminate | | 16 | 17 | 18 | 4 | 5 | 6 |
| Haze | ASTM | 0.32 | 0.29 | 0.22 | 0.23 | 0.31 | 0.33 |
| | D1003 | | | | | | |
| Adhesion | Cross-cut | 100/100 | 100/100 | 100/100 | 18/100 | 12/100 | 10/100 |
| | peeling | | | | | | |
| | test | | | | | | |
| Antistatic | Surface | 5.0 × 10¹³ | 2.9 × 10¹³ | 1.2 × 10¹¹ | 7.5 × 10⁹ | 2.7 × 10⁹ | 1.1 × 10¹⁰ |
| perfor- | resistivity | | | | | | |
| mance | (Ω/ | | | | | | |

In Table 1, the amount of the reactive ATO sol indicates the weight of dry fine particles included in the charged dispersion sol (excluding organic solvent).

The meanings of the abbreviations shown in Table 1 are as follows. Component (B)

PETA-IPDI-PETA

PETA-TDI-PETA

HEA-IPDI-HEA

HEA-TDI-HEA

U-15HA

U-6HA

U-6LPA

U-324A

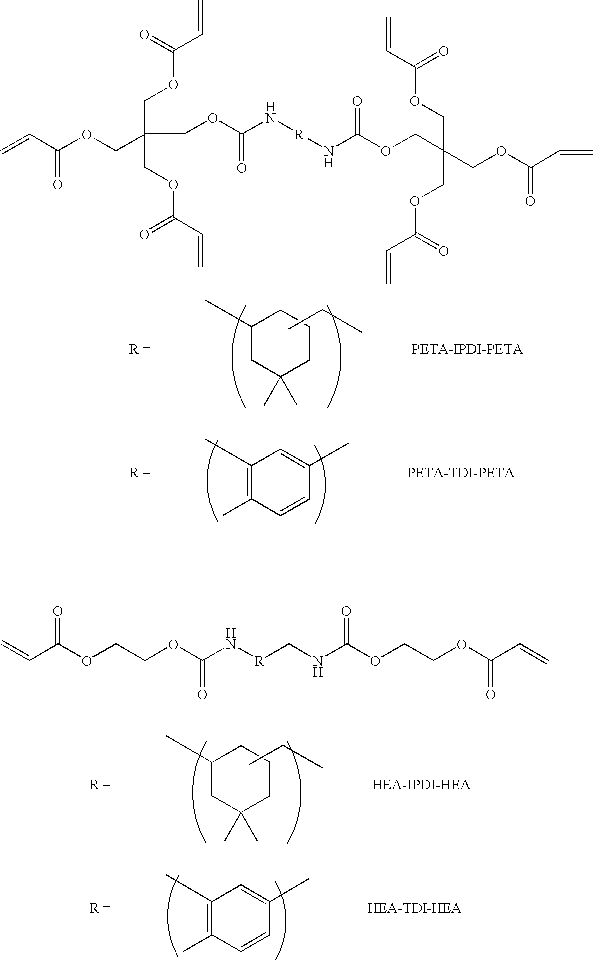

TABLE 2

| | Theoretical | Number of | |
|---|---|---|---|
| Name | molecular weight | functional groups | Chemical formula |
| U-6HA | 1146 | 6 | (1) |
| U-6LPA | 818 | 6 | (2) |
| U-15HA | 2300 | 15 | (1) |
| U-324A | 350-1300 | 6-10 | (2) |

Chemical formulas for Table 2: 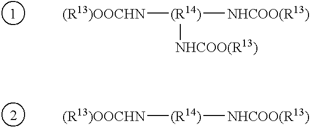
wherein R¹³ is an acryl residue and R¹⁴ is an isocyanate residue.
Component (C)
Irgacure 907 (manufactured by Ciba Specialty Chemicals Co., Ltd.), photoinitiator; 2-methyl-1-[4-(methylthio)phenyl]-2-morpholinopropan-1-one
Component (D)
DPHA: KAYARAD DPHA (manufactured by Nippon Kayaku Co., Ltd., the compound of the following structural formula) 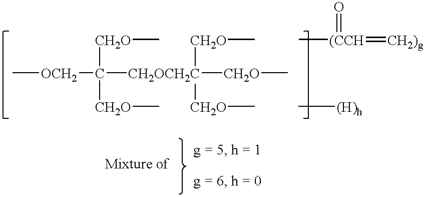
PETA: KAYARAD PETA (manufactured by Nippon Kayaku Co., Ltd., the compound of the following structural formula) 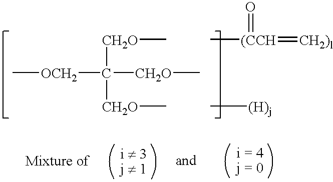
TMPTA: KAYARAD TMPTA (manufactured by Nippon Kayaku Co., Ltd., the compound of the following structural formula)

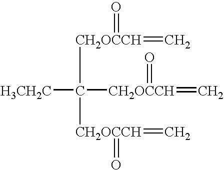

It can be seen from the results of Table 1 that the adhesion is excellent in the Examples in which the compound (B) having a urethane bond is used, whereas the adhesion is inferior in the Comparative Examples not containing the compound (B) having a urethane bond. In addition, the results of the Examples indicate that in spite of the use of a polyfunctional acrylate having a urethane bond to significantly improve the adhesion, the compositions exhibiting the same degree of excellent antistatic performance as the compositions of Comparative Examples using a polyfunctional acrylate having no urethane bond by properly selecting the types of components and their proportion.

### INDUSTRIAL APPLICABILITY

The curable composition, the cured product, and the laminate of the present invention are suitable as a protective coating material for preventing occurrence of scratches or stains on plastic optical parts, touch panels, film-type liquid crystal elements, plastic containers, and flooring materials, wall materials, and artificial marbles used as architectural interior finish; an antireflection film for film-type liquid crystal elements, touch panels, or plastic optical parts; an adhesive or a sealing material for various types of substrates; a binder for printing ink; and the like. The curable composition, the cured product, and the laminate can be particularly suitably used as an antireflection film.

Moreover, because the laminate of the present invention is excellent in the antistatic property, the laminate is useful in the application to prevent adhesion of dust on various panels such as a CRT, liquid crystal display panel, plasma display panel, and electroluminescence display panel, as an electromagnetic radiation shield, and as an antistatic antireflection film.

1. A curable composition comprising:
(A) particles prepared by bonding oxide particles of at least one element selected from the group consisting of silicon, aluminum, zirconium, titanium, zinc, germanium, indium, tin, antimony, and cerium with an organic compound having a polymerizable unsaturated group,
(B) a compound having a urethane bond and two or more polymerizable unsaturated groups in the molecule, and
(C) a photoinitiator.

2. The curable composition according to claim 1, also comprising (D) a compound having two or more polymerizable unsaturated groups in the molecule other than component (B).

3. The curable composition according to claim 1, wherein the organic compound having a polymerizable unsaturated group in component (A) additionally comprises a group shown by formula (1),
—U—C(═V)—NH— (1)
wherein U represents NH, O, or S, and V represents O or S.

4. The curable composition according to claim 1, wherein the oxide particles of said component (A) are antimony-doped tin oxide particles.

5. A cured product obtained by curing the curable composition according to claim 1.

6. A laminate comprising a film of the cured product according to claim 5.

7. The laminate according to claim 6, wherein said film has a high refractive index.

8. The laminate according to claim 6, wherein said laminate also comprises a low-refractive-index film having a refractive index of 1.38-1.45.

9. The laminate according to claim 6, wherein said laminate also comprises a substrate.

10. The laminate according to claim 8, wherein said laminate additionally comprises another film located between the cured film having high refractive index and the film having a refractive index of 1.38-1.45.

11. The laminate according to claim 6, wherein said laminate has a cross-cut peeling value from 70/100 to 100/100.

12. The laminate according to claim 11, wherein said laminate has a surface resistivity of 1.5×10⁹ Ω/square or higher.

13. (canceled)

14. The laminate according to claim 11, wherein said cure product has a haze value of 0.22 or higher.

15. A method of using the laminate according to claim 6 as a laminate having antireflection and antistatic properties.
